(19) United States
(12) Patent Application Publication
(10) Pub. No.: US 2024/0014523 A1
(43) Pub. Date: Jan. 11, 2024

(54) ELECTRODE ASSEMBLY, BATTERY CELL COMPRISING THE SAME AND METHOD FOR MANUFACTURING SAID BATTERY CELL

(71) Applicant: SK ON CO., LTD., Seoul (KR)

(72) Inventors: Kyu Beom KIM, Daejeon (KR); Chae Rin RYOU, Daejeon (KR); Hyeon Su BAE, Daejeon (KR); Ye Jin YUN, Daejeon (KR); Jeong Hyeon YUN, Daejeon (KR); Hyea Won YUN, Daejeon (KR); Ji Hyeon LEE, Daejeon (KR); Jong Chan IM, Daejeon (KR)

(21) Appl. No.: 18/346,861

(22) Filed: Jul. 5, 2023

(30) Foreign Application Priority Data
Jul. 6, 2022 (KR) 10-2022-0082829
May 23, 2023 (KR) 10-2023-0066205

(51) Int. Cl. H01M 50/538; H01M 4/04; H01M 50/46

(52) U.S. Cl. CPC H01M 50/538; H01M 4/0404; H01M 50/46

(57) ABSTRACT

The present disclosure relates to an electrode assembly, a battery cell, and a method for manufacturing a battery cell, and provides an electrode assembly capable of preventing breakage of a current collector improving stability of a battery cell.

### CROSS-REFERENCE TO RELATED PATENT APPLICATION

The present application claims priority under 35 U.S.C. § 119(a) to Korean patent application number 10-2022-0082829 filed on Jul. 6, 2022 and Korean patent application number 10-2023-0066205 filed on May 23, 2023, in the Korean Intellectual Property Office, the entire disclosure of which is incorporated by reference herein.

### BACKGROUND OF THE INVENTION

### 1. Field

The present disclosure relates to an electrode assembly.

In addition, the present disclosure relates to a battery cell including the electrode assembly.

In addition, the present disclosure relates to a method for manufacturing said battery cell.

### 2. Description of the Related Art

As the electronics, communications, and space industries develop, demand for secondary batteries as an energy power source is drastically increasing. In particular, as the importance of global eco-friendly policies is emphasized, the electric vehicle market is growing swiftly, and research and development on secondary batteries are being actively conducted worldwide.

Among various secondary batteries, research and development of lithium secondary batteries is being most actively conducted, because lithium secondary batteries have high discharge voltage and energy density. In an electrode assembly constituting a lithium secondary battery, a plurality of unit cells in which a separator is interposed between a cathode and an anode are laminated. Here, a plurality of cathodes and anodes of each unit cell may be welded and bundled into one. FIGS. 1A to 1C are a schematic diagram of a conventional electrode assembly manufacturing method. In an electrode assembly 1, a plurality of unit cells comprising a first electrode comprising a first current collector 2 and a first active material layer formed on at least one surface of the first current collector; a second electrode comprising a second current collector 3 and a second active material layer formed on at least one surface of the second current collector; and a separator interposed between the first electrode and the second electrode are laminated. An electrode assembly may be manufactured by bundling each of a first current collector 2 and a second current collector 3 of each unit cell extending out of the stacks and applying pressure P thereto and then welding an electrode lead 4 thereto. As a result, electric current may be supplied to each electrode.

However, in the process of bundling a plurality of first current collectors 2 and second current collectors 3, a relatively strong tension T may be applied to current collectors located at an edge. As a result, the first current collector 2 and the second current collector 3were broken while welding an electrode lead 4 or during the operation of secondary batteries. Breakage of the first current collector 2 and the second current collector 3 may short-circuit an electrode and may generate an overcurrent, causing ignition and explosion of secondary batteries. Therefore, it is necessary to develop a technology capable of preventing breakage of current collectors.

### SUMMARY OF THE INVENTION

One object of the present disclosure is to provide an electrode assembly capable of preventing breakage of a current collector.

Another object of the present disclosure is to provide a battery cell capable of improving stability by comprising the electrode assembly.

Another object of the present disclosure is to provide a method for conveniently manufacturing the battery cell.

The electrode assembly according to an Embodiment of the present disclosure comprises a unit cell stack comprising a first unit cell and a second unit cell which is the closest unit cell on the first unit cell, each of the first unit cell and the second unit cell comprising a first electrode comprising a first current collector and a first active material layer on at least one surface of the first current collector, a second electrode, which is an opposite electrode of the first electrode, comprising a second current collector and a second active material layer on at least one surface of the second current collector, and a separator interposed between the first electrode and the second electrode; and a first electrode tab first side portion comprising a first current collector first side deformation portion in which one end in the width direction of the first current collector of each of the first unit cell and the second unit cell is folded or rolled, wherein a shortest distance from an upper surface of the first current collector of the second unit cell to an upper surface of the first current collector of the first unit cell is the same as the height of the first current collector first side deformation portion of the second unit cell.

A battery cell according to one Embodiment of the present disclosure comprises the electrode assembly and an electrode lead connected to an electrode tab first side portion of the first electrode tab of the electrode assembly.

A method for manufacturing a battery cell according to an Embodiment of the present disclosure comprises preparing the electrode assembly; and connecting an electrode lead to a first electrode tab first side portion of the electrode assembly.

The electrode assembly according to an Embodiment of the present disclosure may prevent breakage of a current collector.

The battery cell according to an Embodiment of the present disclosure may improve stability.

The method for manufacturing a battery cell according to an Embodiment of the present disclosure may be used to conveniently manufacture the battery cell.

### BRIEF DESCRIPTION OF THE DRAWINGS

FIGS. 1A, 1B and 1C are a schematic diagram of a conventional electrode assembly manufacturing method.

FIGS. 2 to 13 are schematic diagrams of an electrode assembly according to an Embodiment of the present disclosure.

FIG. 14 is a schematic diagram of a battery cell according to an Embodiment of the present disclosure.

FIGS. 15A, 15B, 15C and 15D are schematic diagrams of a unit cell stack manufacturing process according to an Embodiment of the present disclosure.

FIGS. 16A, 16B, 16C and 16D are schematic diagrams of a unit cell stack manufacturing process according to an Embodiment of the present disclosure.

FIGS. 17A, 17B, 17C and 17D are schematic diagrams of a unit cell stack manufacturing process according to an Embodiment of the present disclosure.

FIGS. 18A, 18B, 18C and 18D are schematic diagrams of a unit cell stack manufacturing process according to an Embodiment of the present disclosure.

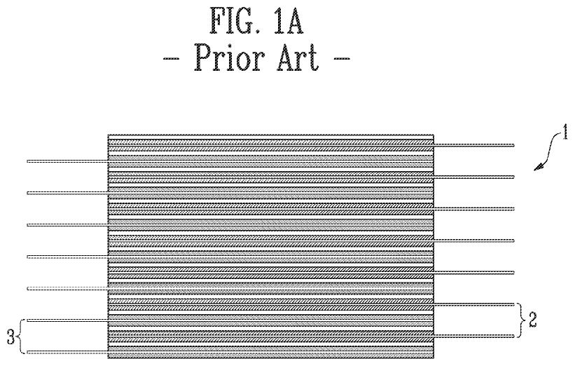

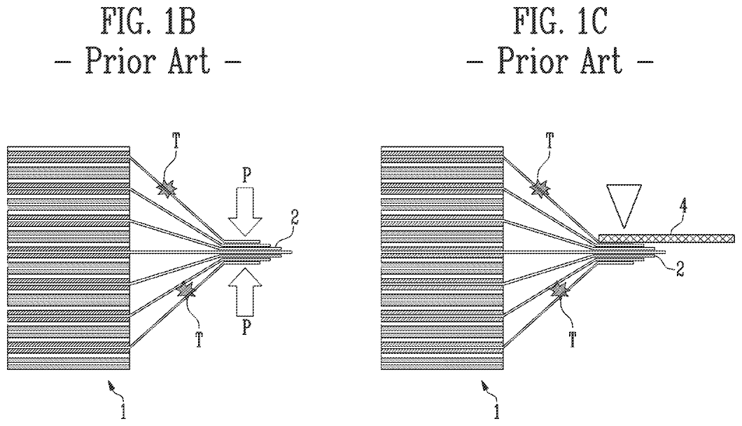

### DETAILED DESCRIPTION

Hereinafter, the present invention will be described in detail with reference to the accompanying drawings.

One Embodiment of the present disclosure relates to an electrode assembly.

In the present specification, the term “battery cell” refers to a basic unit of a lithium secondary battery capable of charging and discharging electrical energy, specifically, of a lithium ion battery. The main components of the battery cell are a cathode, an anode, a separator, and an electrolyte. The battery cell comprises these main components and a case accommodating the same. The term ‘battery cell’ is usually used in a meaning that is different from a battery module and a battery pack.

In the present specification, the term “electrode assembly” refers to an element in which an electrochemical reaction for converting chemical energy into electrical energy occurs in a battery cell. Therefore, a battery cell comprises an electrode assembly and a case accommodating the same. Specifically, the battery cell comprises an electrode assembly, an electrode lead connected thereto to supply current to each electrode, and a case accommodating the electrode assembly.

An electrode assembly comprises at least a unit cell stack and an electrode tab. A unit cell refers to the smallest unit of a battery, comprising a cathode, an anode, and a separator interposed between the cathode and the anode. The cathode comprises a cathode current collector and a cathode active material layer on at least one surface of the cathode current collector. The anode comprises an anode current collector and an anode active material layer on at least one surface of the anode current collector. The electrode tab refers to a portion at which a current collector constituting the unit cell stack is connected to an electrode lead.

In the present specification, the description that two values are equal to each other may comprise both the case when the two values perfectly coincide and the case when the difference between the two values is within an error range (for example, within ±5%, within ±3%, within ±1%).

In the present specification, the description that two elements are perpendicular or parallel to each other may comprise both the case when the angle formed by the two elements is a perfectly right angle or when the two elements are perfectly parallel and the case where the angle formed by the two elements is within an error range from a right angle or 180 degrees (for example, ±within 5%, within ±3%, within ±1%).

An electrode assembly according to an Embodiment of the present disclosure comprises at least a unit cell stack 10 and an electrode tab 20.

The unit cell stack comprises at least two unit cells. The unit cell stack comprises a first unit cell 11 and a second unit cell 12. The second unit cell 12 is the closest unit cell on the first unit cell 11.

Each of the first unit cell 11 and the second unit cell 12 has the configuration of the electrode assembly described above. Specifically, each of the first unit cell 11 and the second unit cell 12 comprises a first electrode, a second electrode, which is an opposite electrode of the first electrode, and a separator 11e, 12e interposed between the first electrode and the second electrode. The first electrode comprises a first current collector 11a, 12a and a first active material layer 11c, 12c on at least one surface of the first current collector 11a, 12a. The second electrode comprises a second current collector 11b, 12b and a second active material layer 11d, 12d on at least one surface of the second current collector 11b, 12b.

Here, when the first electrode is a cathode, the first current collector 11a, 12a is a cathode current collector, the first active material layer 11c, 12c is a cathode active material layer, the second electrode is an anode, the second current collector 11b, 12b is an anode current collector, and the second active material layer 11d, 12d is an anode active material layer. Conversely, when the first electrode is an anode, the first current collector 11a, 12a is an anode current collector, the first active material layer 11c, 12c is an anode active material layer, the second electrode is a cathode, the second current collector 11b, 12b is a cathode current collector, and the second active material layer 11d, 12d is a cathode active material layer.

A current collector plays the role of providing electrons from the outside to an active material or receive electrons from an active material and send them to the outside. Lithium secondary batteries usually use an aluminum current collector as a cathode current collector. Lithium secondary batteries usually use a copper current collector as an anode current collector.

A cathode active material is a material that plays the role of providing lithium ions to an anode during charging of a battery. A cathode active material of lithium secondary batteries comprises LCO, LMO, NCM, NCA, LFP, and the like. An anode active material is a material that plays the role of storing lithium ions during battery charging. A typical anode active material of lithium secondary batteries is graphite.

An electrode assembly 100 of the present disclosure comprises at least a first electrode tab first side portion 21a constituted by a first current collector 11a extending from one end in the width direction of a unit cell stack 10.

In the present specification, the height direction may refer to a direction parallel to the opposite direction of gravity. The width direction may refer to a direction that is perpendicular to the height direction and that is a longer direction among two mutually perpendicular directions. The longitudinal direction may refer to a direction that is perpendicular to the height direction and that is a shorter direction among two mutually perpendicular directions other than the width direction, which is a longer direction.

In an electrode assembly 100 of the present disclosure, when the first electrode tab first side portion 21a is deformed into a specific shape and the first unit cell 11 and the second unit cell 12 satisfy a specific relationship, each electrode tab may be formed side by side with each unit cell. At this time, in a process coupling (or welding) an electrode lead to an electrode assembly 100, tension may not be applied to an electrode tab. Therefore, the electrode assembly 100 of the present disclosure may prevent breakage of a current collector during utilization process.

The first electrode tab first side portion 21a comprises a first current collector first side deformation portion 21aa, which is formed by folding or rolling one end of each of the first current collector 11a, 12a of the first unit cell 11 and the second unit cell 12. Therefore, each of the first unit cell 11 and the second unit cell 12 comprises a first current collector first side deformation portion 21aa of which an end is folded or rolled. Here, the direction in which the current collector is deformed may be downward as the gravity direction.

In the electrode assembly 100 of the present disclosure, when the height H1 of a first current collector first side deformation portion 21aa of a unit cell located on an upper portion is the same as a shortest distance H1 from a first current collector of a unit cell located on an upper portion to a first current collector of a unit cell located on a lower portion, unnecessary tension may not be applied to a first electrode tab first side portion 21a.

Here, the thickness of the unit cell located on an upper portion may be the same as or different from the thickness of the unit cell located on a lower portion.

The height of a deformation portion may refer to a shortest distance from a uppermost surface to a lowermost surface of the deformation portion.

In other words, in an electrode assembly 100 of the present disclosure, a shortest distance H1 from the topmost end of a first current collector of the second unit cell 12 to the topmost end of a first current collector of the first unit cell 11 is equal to a shortest distance H1 from the topmost end to the bottommost end of a first current collector first side deformation portion 21aa of the second unit cell 12.

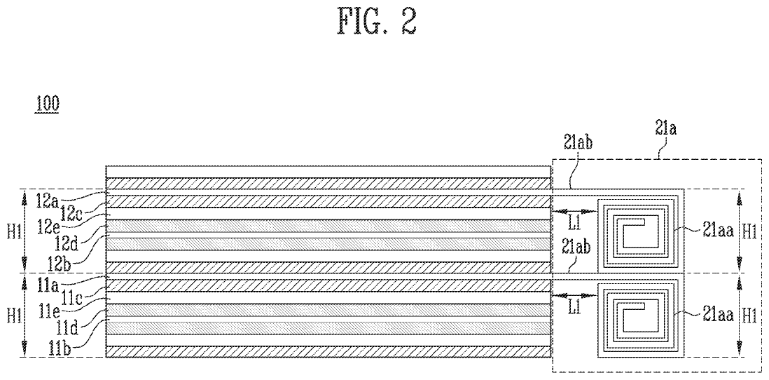

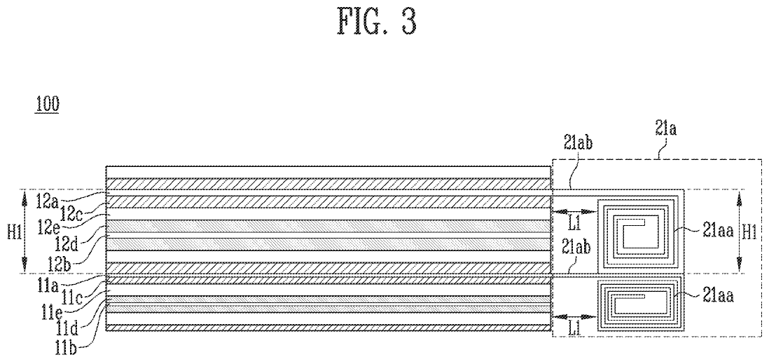

FIGS. 2 and 3 are schematic diagrams of an electrode assembly 100 at this time. Referring to FIGS. 2 and 3, the electrode assembly 100 comprises a unit cell stack 10 comprising a first unit cell 11 and a second unit cell 12 and a first electrode tab first side portion 21a. A first electrode tab first side portion 21a comprises a first current collector first side deformation portion 21aa. A shortest distance H1 from the topmost end of a first current collector of a second unit cell 12 to the topmost end of a first current collector 11a of a first unit cell 11 is the same as the height of the first current collector first side deformation portion 21aa. FIG. 2 shows a case where the thickness of individuals unit cells is the same. FIG. 3 shows a case where the thickness of individuals unit cells is different from each other.

In one Embodiment, an electrode assembly 100 of the present disclosure comprises a second electrode tab second side portion 22b constituted by a second current collector 11b, 12b, 13b, 14b extending from the other end in the width direction of a unit cell stack 10.

The electrode assembly 100 may further comprise a second electrode tab second side portion 22b comprising a second current collector second side deformation portion 22ba in which the other end in the width direction of the second current collector 11b, 12b of each of the first unit cell 11 and the second unit cell 12 is folded or rolled. In addition, in one Embodiment, a shortest distance H2 from the topmost end of a second current collector 12b of the second unit cell 12 to the topmost end of a second current collector 11b of the first unit cell 11 may be the same as the height H2 of a second current collector second side deformation portion 22ba of the second unit cell 12.

In other words, an electrode tab of the second electrode may be formed on the opposite side of an electrode tab of the first electrode. An electrode tab of the second electrode may be a second electrode tab second side portion 22b located on the opposite side of the first electrode. The second electrode tab second side portion 22b may also comprise a second current collector 11b, 12b deformed into a specific shape like a first electrode tab first side portion 21a. The relationship satisfied for the first current collector 11a, 12a may be the same for the second current collector 11b, 12b.

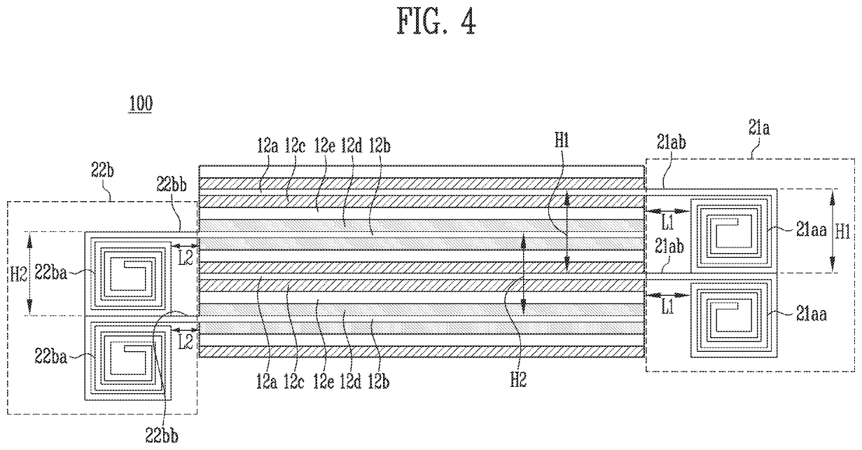

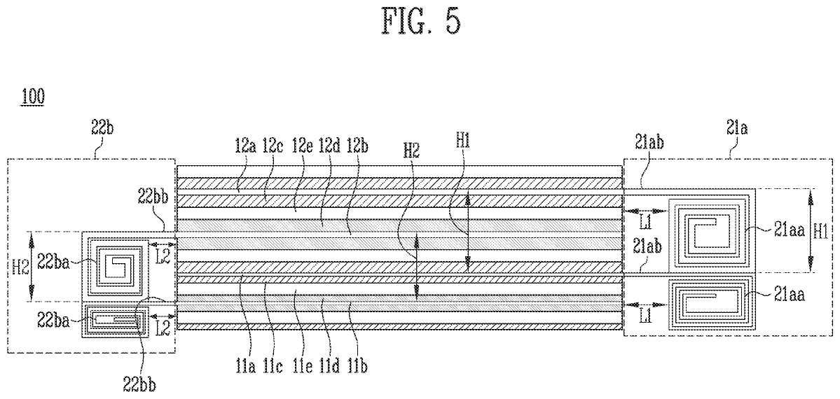

FIGS. 4 and 5 are schematic diagrams of an electrode assembly 100 at this time. Referring to FIGS. 4 and 5, the electrode assembly 100 may further comprise a second electrode tab second side portion 22b. A second electrode tab second side portion 22b may comprise a second current collector second side deformation portion 22ba. A shortest distance H2 from the topmost end of a second current collector 12b of a second unit cell 12 to the topmost end of a second current collector 11b of a first unit cell 11 may be the same as the height H2 of the second current collector second side deformation portion 22ba. FIG. 4 shows a case where the thickness of individuals unit cells is the same. FIG. 5 shows a case where the thickness of individuals unit cells is different from each other.

In one Embodiment, the electrode assembly 100 of the present disclosure may comprise a second electrode tab first side portion 22a constituted by a second current collector 11b, 12b, 13b, 14b extending from one end in the width direction of a unit cell stack 10.

The electrode assembly 100 may further comprise a second electrode tab first side portion 22a comprising a second current collector first side deformation portion 21aa in which one end in the width direction of the second current collector 11b, 12b of each of the first unit cell 11 and the second unit cell 12 is folded or rolled. In addition, in one Embodiment, a shortest distance H2 from an upper surface of a second current collector 12b of the second unit cell 12 to an upper surface of a second current collector 11b of the first unit cell 11 may be the same as the height H2 of a second current collector first side deformation portion 22aa of the second unit cell 12.

In other words, an electrode tab of the second electrode may be formed on the same side as the electrode tab of the first electrode. An electrode tab of the second electrode may be a second electrode tab first side portion 22a located on the same side as the electrode tab of the first electrode. The second electrode tab first side portion 22a may also comprise a second current collector 11b, 12b deformed into a specific shape like the first electrode tab first side portion 21a. The relationship satisfied for the first current collector 11a, 12a may be the same for the second current collector 11b, 12b.

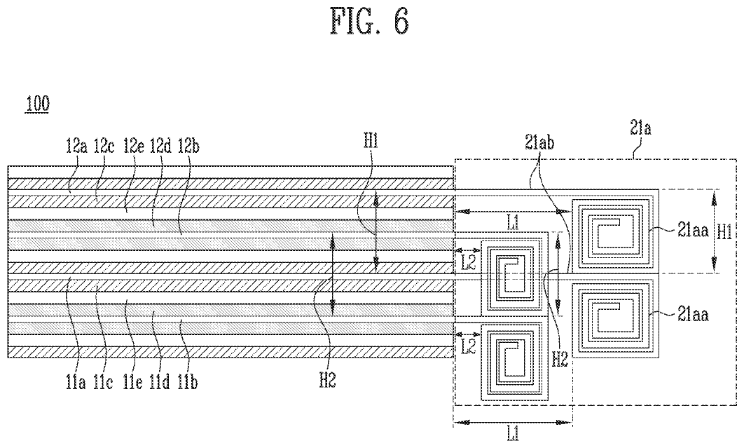

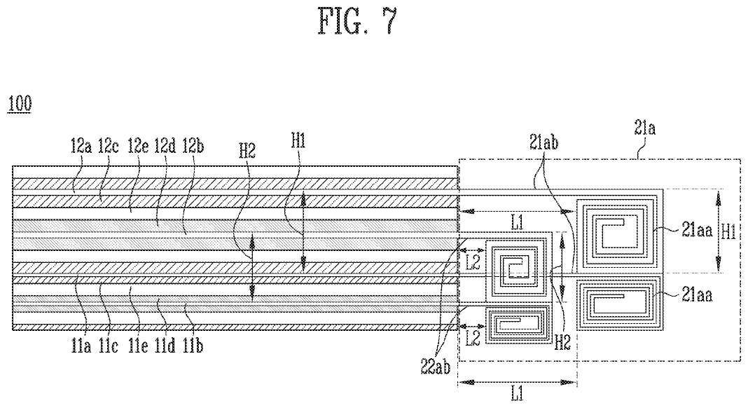

FIGS. 6 and 7 are schematic diagrams of an electrode assembly 100 at this time. Referring to FIGS. 6 and 7, the electrode assembly 100 may further comprise a second electrode tab first side portion 22a. A second electrode tab first side portion 22a may comprise a second current collector first side deformation portion 22aa. A shortest distance H2 from the topmost end of a second current collector 12b of a second unit cell 12 to the topmost end of a second current collector 11b of a first unit cell 11 may be the same as the height H2 of the second current collector first side deformation portion 22aa. FIG. 6 shows a case where the thickness of individuals unit cells is the same. FIG. 7 shows a case where the thickness of individuals unit cells is different from each other.

In one Embodiment, the electrode assembly 100 of the present disclosure may comprise a first electrode tab first side portion 22b constituted by a first current collector 11a, 12a, 13a, 14a extending from the other end in the width direction of a unit cell stack 10 (not shown). At this time, a cathode and an anode may be formed on both of one side and the other side of a battery cell.

The sequence in which the first unit cell 11 and the second unit cell 12 are laminated in the unit cell stack 10 is not limited.

In one Embodiment, the first unit cell 11 and the second unit cell 12 may be sequentially laminated. The description that the first unit cell 11 and the second unit cell 12 are sequentially laminated may mean that the first unit cell 11 and the second unit cell 12 are laminated in an order of anode/separator/cathode/separator/anode/separator/cathode or cathode/separator/anode/separator/cathode/separator/anode.

In another Embodiment, the first unit cell 11 and the second unit cell 12 may be alternately laminated. The fact that the first unit cell 11 and the second unit cell 12 are alternately laminated may mean that the first unit cell 11 and the second unit cell 12 are laminated in an order of anode/separator/cathode/separator (optional)/cathode/separator/anode or cathode/separator/anode/separator (optional)/anode/separator/cathode.

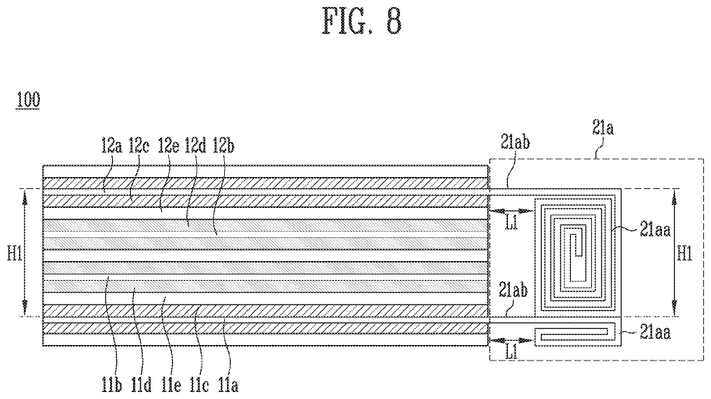

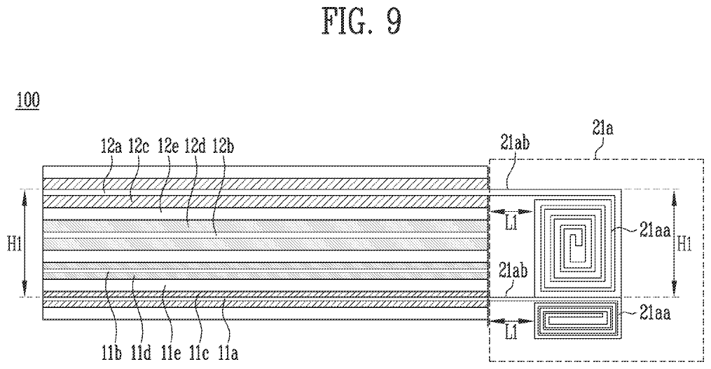

FIGS. 8 and 9 are schematic diagrams of the electrode assembly 100 at this time. Referring to FIGS. 8 and 9, in the unit cell stack 10, the first unit cell 11 and the second unit cell 12 are alternately laminated. At this time, a shortest distance H1 from an upper surface of a first current collector 12a of the second unit cell 12 to an upper surface of a first current collector 11a of the first unit cell 11 may be the same as the height H1 of the first current collector first side deformation portion 21aa. FIG. 8 shows a case where the thickness of individuals unit cells is the same. FIG. 9 shows a case where the thickness of individuals unit cells is different from each other.

In one Embodiment, there may be an undeformed portion in the electrode tab. Therefore, an electrode tab may comprise an undeformed portion between the deformation portion and the unit cell stack 10. The electrode current collector at this time is shown in FIGS. 2 to 9.

In one Embodiment, the electrode tab of the first electrode may further comprise an undeformed portion extending without modification from the unit cell stack 10 besides the first current collector first side deformation portion 21aa and the first current collector second side deformation portion 21ba. When undeformed portions of one side or the other side of an electrode tab of a first electrode of each of the first unit cell 11 and the second unit cell are parallel to each other and the length L1 of each of them is the same with each other, a first electrode tab first side portion 21a and/or a first electrode tab second side portion 21b of each unit cell may be formed side by side with a first current collector of each unit cell.

In one Embodiment, the first electrode tab first side portion 21a may further comprise a first current collector first side undeformed portion 21ab which is between the unit cell stack 10 and the first current collector first side deformation portion 21aa and in which a first current collector 11a, 12a of each of the first unit cell 11 and the second unit cell 12 is extended in the width direction. A first current collector first side undeformed portion 21ab of the first unit cell 11 may be parallel to a first current collector first side undeformed portion 21ab of the second unit cell 12. The length L1 of a first current collector first side undeformed portion 21ab of the first unit cell 11 may be the same as the length L1 of a first current collector first side undeformed portion 21ab of the second unit cell 12. The electrode current collector at this time is shown in FIGS. 2 and 3.

In one Embodiment, the first electrode tab second side portion 21b may further comprise a first current collector second side undeformed portion 21bb which is between the unit cell stack and the first current collector second side deformation portion 21aa and in which a first current collector 11a, 12a of each of the first unit cell 11 and the second unit cell 12 is extended in the width direction (not shown). A first current collector second side undeformed portion 21bb of the first unit cell 11 may be parallel to a first current collector second side undeformed portion 21bb of the second unit cell 12. The length L1 of a first current collector second side undeformed portion 21bb of the first unit cell 11 may be the same as the length L1 of a first current collector second side undeformed portion 21bb of the second unit cell 12.

In one Embodiment, the electrode tab of the second electrode may further comprise an undeformed portion extending without modification from the unit cell stack 10 besides the second current collector first side deformation portion 22aa and the second current collector second side deformation portion 22ba. When undeformed portions of one side or the other side of an electrode tab of a second electrode of each of the first unit cell 11 and the second unit cell are parallel to each other and the length L2 of each of them is the same with each other, a second electrode tab first side portion 22a and/or a second electrode tab second side portion 22b of each unit cell may be formed side by side with a second current collector of each unit cell.

In one Embodiment, the second electrode tab second side portion 22b may further comprise a second current collector second side undeformed portion 22bb which is between the unit cell stack 10 and the second current collector second side deformation portion 21ba and in which a second current collector 11b, 12b of each of the first unit cell 11 and the second unit cell 12 is extended in the width direction. A second current collector second side undeformed portion 22bb of the first unit cell 11 may be parallel to a second current collector second side undeformed portion 22bb of the second unit cell 12. The length L2 of a second current collector second side undeformed portion 22bb of the first unit cell 11 may be the same as the length L2 of a second current collector second side undeformed portion 22bb of the second unit cell 12. The electrode current collector at this time is shown in FIGS. 4 and 5. Specifically, FIGS. 4 and 5 show an aspect in which the first electrode tab is on a different side of the second electrode tab. FIG. 4 shows a case where the thickness of individuals unit cells is the same. FIG. 5 shows a case where the thickness of individuals unit cells is different from each other.

In one Embodiment, the second electrode tab first side portion 22a may further comprise a second current collector first side undeformed portion 22ab which is located between the unit cell stack 10 and the second current collector first side deformation portion 22aa and in which a second current collector 11b, 12b of each of the first unit cell 11 and the second unit cell 12 is extended in the width direction. A second current collector first side undeformed portion 22ab of the first unit cell 11 may be parallel to a second current collector first side undeformed portion 22ab of the second unit cell 12. The length L2 of a second current collector first side undeformed portion 22ab of the first unit cell 11 may be the same as the length L2 of a second current collector first side undeformed portion 22ab of the second unit cell 12. The electrode current collector at this time is shown in FIGS. 6 and 7. FIGS. 6 and 7 show an aspect in which the first electrode tab is on the same side as the second electrode tab. FIG. 6 shows a case where the thickness of individuals unit cells is the same. FIG. 7 shows a case where the thickness of individuals unit cells is different from each other.

Even when there is an undeformed portion in the electrode tab, the order in which the first unit cell 11 and the second unit cell 12 are laminated in the unit cell stack 10 is not limited. In one Embodiment, the first unit cell 11 and the second unit cell 12 may be sequentially laminated. In another Embodiment, the first unit cell 11 and the second unit cell 12 may be alternately laminated. The electrode current collector at this time is shown in FIGS. 8 and 9. FIG. 8 shows a case where the thickness of individuals unit cells is the same. FIG. 9 shows a case where the thickness of individuals unit cells is different from each other.

The aspect mentioned above may also be applied without modification even when a unit cell stack of an electrode assembly of the present disclosure comprises a number of unit cells.

In one Embodiment of the present disclosure, the unit cell stack 10 may further comprise a third unit cell 13 and a fourth unit cell 14 which is the closest unit cell on the third unit cell 13. In addition, each of the third unit cell 13 and the fourth unit cell 14 may comprise a first electrode comprising a first current collector 13a, 14a and a first active material layer 13c, 14c on at least one side of the first current collector 13a, 14a, a second electrode which is an opposite electrode of the first electrode, comprising a second current collector 13b, 14b and a second active material layer 13d, 14d on at least one side of the second current collector 13b, 14b, and a separator 13e, 14e interposed between the first electrode and the second electrode. In addition, the first electrode tab first side portion 21a may further comprise a first current collector first side deformation portion 21aa in which one end in the width direction of the first current collector 13a, 14a of each of the third unit cell 13 and the fourth unit cell 14 is folded or rolled.

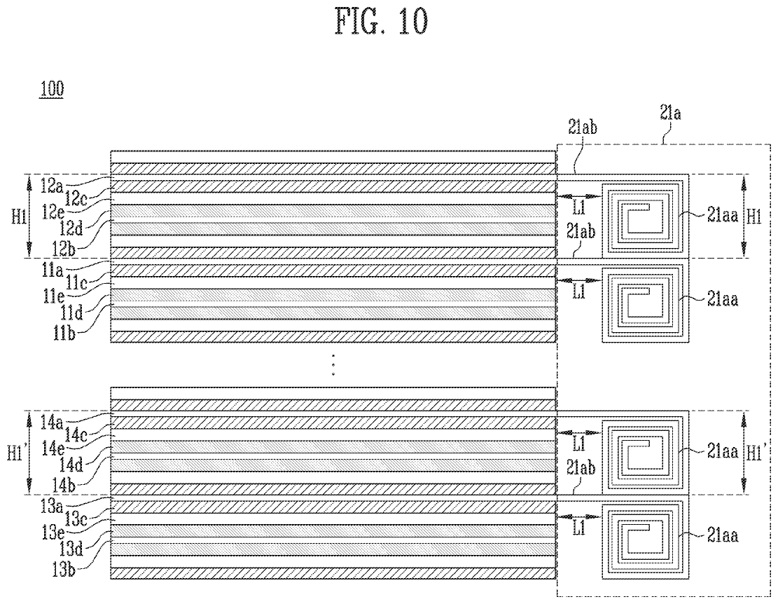

At this time, a shortest distance H1′ from an upper surface of a first current collector 14a of the fourth unit cell 14 to an upper surface of a first current collector 13a of the third unit cell 13 may be the same as the height H1′ of a first current collector first side deformation portion 21aa of the fourth unit cell 14. The electrode assembly at this time is shown in FIGS. 10 to 13.

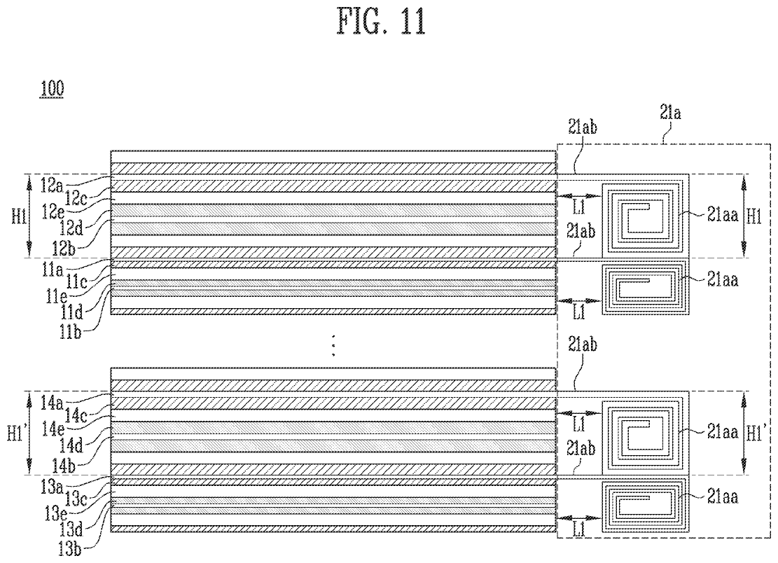

In one Embodiment, a shortest distance H1′ from an upper surface of a first current collector 14a of the fourth unit cell 14 to an upper surface of a first current collector 13a of the third unit cell 13 may be the same as a shortest distance H1 from an upper surface of a first current collector 12a of the second unit cell 12 to an upper surface of a first current collector 11a of the first unit cell 11. FIG. 10 shows a case where the thickness of the fourth unit cell is the same as the thickness of the third unit cell and the thickness of the second unit cell is the same as the thickness of the first unit cell. FIG. 11 shows a case where the thickness of the fourth unit cell is different from the thickness of the third unit cell and the thickness of the second unit cell is different from the thickness of the first unit cell.

In one Embodiment, a shortest distance H1′ from an upper surface of a first current collector 14a of the fourth unit cell 14 to an upper surface of a first current collector 13a of the third unit cell 13 may be different from a shortest distance H1 from an upper surface of a first current collector 12a of the second unit cell 12 to an upper surface of a first current collector 11a of the first unit cell 11. The electrode current collector at this time is shown in FIGS. 12 and 13. FIG. 12 shows a case where the thickness of the fourth unit cell is the same as the thickness of the third unit cell and the thickness of the second unit cell is the same as the thickness of the first unit cell. FIG. 13 shows a case where the thickness of the fourth unit cell is different from the thickness of the third unit cell and the thickness of the second unit cell is different from the thickness of the first unit cell.

In other words, in the electrode assembly 100, when the thickness of each unit cell is the same as the height of a current collector deformation portion of each unit cell, the thickness of each of the unit cells may be the same with or different from each other. In addition, the first electrode tab and/or the second electrode tab may further comprise an undeformed portion. The description above may be applied without modification to the description of the undeformed portion.

In one Embodiment, the height H1, H2 of each of the first current collector first side deformation portion 21aa, the first current collector second side deformation portion 21ba, the second current collector first side deformation portion 22aa, and the second current collector second side deformation portion 22ba may be the same with each other.

In this way, when the shape of an electrode tab is deformed such that the electrode tab is on the same line as an electrode collector in an electrode assembly 100, unnecessary tension may not be applied in a process of manufacturing a battery cell with an electrode assembly 100. As a result, a battery cell may be manufactured even when an electrode lead is connected to the electrode current collector without a separate process of applying pressure.

Another Embodiment of the present disclosure relates to a battery cell comprising the electrode assembly 100. The battery cell may comprise an electrode assembly 100 and an electrode lead connected to a first electrode tab first side portion 21a of the electrode assembly 100. The electrode lead may be a lead of a first electrode. In addition, the connection method is not particularly limited. Normally, an electrode lead is connected to an electrode tab by welding.

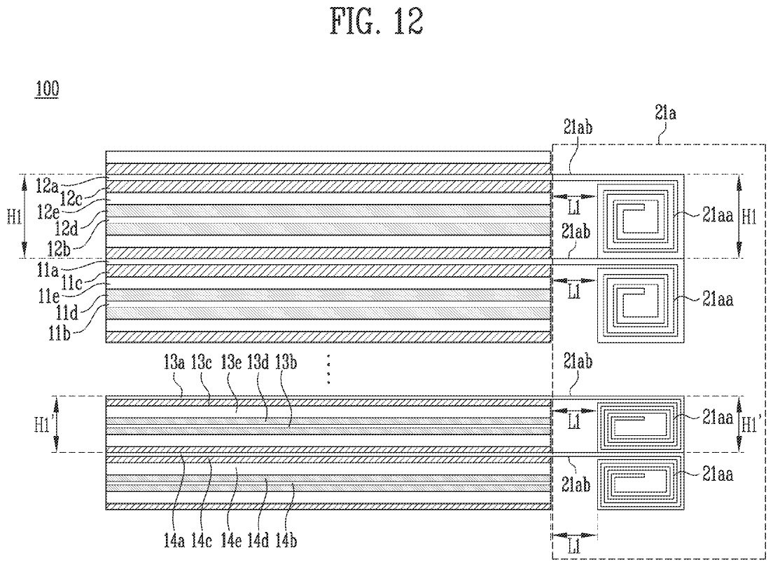

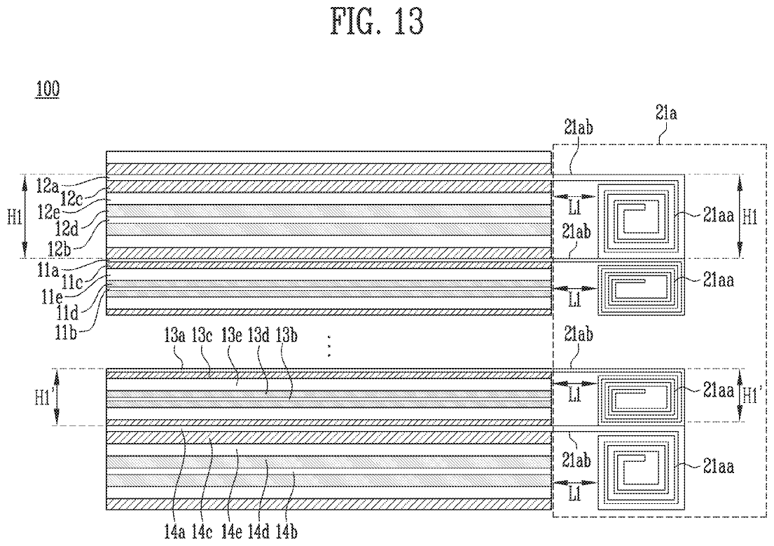

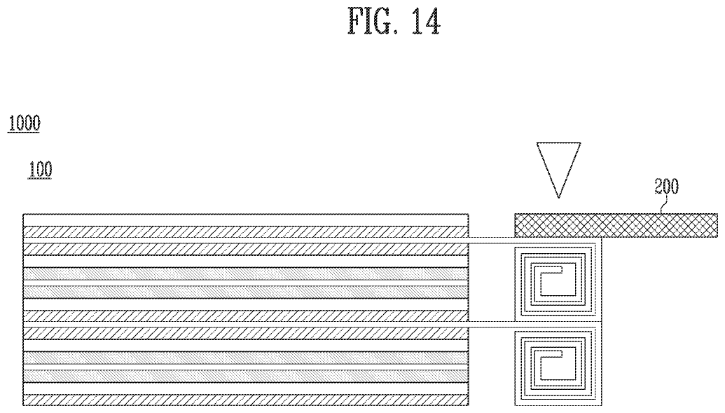

FIG. 14 is a schematic diagram of a battery cell according to an Embodiment of the present disclosure. A battery cell comprises the electrode assembly 100 and an electrode lead, and the electrode lead is connected to an electrode tab (a first electrode tab first side portion) of the electrode assembly 100.

In one Embodiment, the battery cell may further comprise an electrode lead connected to a second electrode tab second side portion 22b of the electrode assembly 100. The electrode lead may be a lead of a second electrode. In other words, in the battery cell, the electrode tab of the first electrode and the electrode tab of the second electrode may be located on different sides.

In one Embodiment, the battery cell may further comprise an electrode lead connected to a second electrode tab first side portion 22a of the electrode assembly 100. The electrode lead may be a lead of a second electrode. In other words, in the battery cell, the electrode tab of the first electrode and the electrode tab of the second electrode may be located on a same side.

In one Embodiment, the battery cell may further comprise an electrode lead connected to a first electrode tab second side portion of the electrode assembly, an electrode lead connected to a second electrode tab first side portion 22a, and an electrode lead connected to a second electrode tab second side portion 22b. An electrode lead connected to the first electrode tab second side portion may be a lead of a first electrode. An electrode lead connected to the second electrode tab first side portion 22a and the second electrode tab second side portion 22b may be a lead of a second electrode. In other words, in the battery cell, the electrode tab of the first electrode and the electrode tab of the second electrode may be located on both sides of the battery.

Another Embodiment of the present disclosure relates to a method for manufacturing a battery cell using the electrode assembly 100. The method for manufacturing a battery cell may comprise: preparing the electrode assembly 100; and connecting an electrode lead 200 to a first electrode tab first side portion 21a of the electrode assembly 100.

In one Embodiment, the connecting an electrode lead may be welding the electrode lead to the electrode tab, and a specific method of the welding is not particularly limited.

In one Embodiment, the preparing the electrode assembly 100 may comprise: preparing a unit cell stack 10 comprising a first unit cell 11 and a second unit cell 12 which is the closest unit cell on the first unit cell 11, wherein each of the first unit cell 12 and the second unit cell 12 comprising a first electrode comprising a first current collector 11a, 12a and a first active material layer 11c, 12c on at least one surface of the first current collector 11a, 12a, a second electrode, which is an opposite electrode of the first electrode, comprising a second current collector 11b, 12b and a second active material layer 11d, 12d on at least one surface of the second current collector 11b, 12b, and a separator 11e, 12e interposed between the first electrode and the second electrode; and folding or rolling one end in the width direction of the first current collector 11a, 12a of each of the first unit cell 11 and the second unit cell 12 to form a first electrode tab first side portion 21a comprising a first current collector first side deformation portion 21aa in which a shortest distance from an upper surface of the first current collector 12a of the second unit cell 12 to an upper surface of the first current collector 11a of the first unit cell 11 is the same as the height of the first current collector first side deformation portion 21aa of the second unit cell 12.

In other words, in one Embodiment, the preparing the electrode assembly 100 may be performed by laminating each unit cell and then processing the stack to satisfy the conditions specified in the present disclosure.

In one Embodiment, the preparing the electrode assembly 100 may comprise folding or rolling one end in the width direction of a first current collector 11a to prepare the first unit cell 11 in which the first current collector first side deformation portion 21aa is formed; and folding or rolling one end in the width direction of a first current collector 11a to locate the second unit cell 12 in which the first current collector first side deformation portion 21aa is formed on the first unit cell 11. The preparing the first unit cell 11 and the locating the second unit cell 12 are performed such that a first electrode tab first side portion 21 comprising a first current collector first side deformation portion 21aa in which a shortest distance from an upper surface of a first current collector 12a of the second unit cell 12 to an upper surface of a first current collector 11a of the first unit cell 11 is the same as the height of a first current collector first side deformation portion 21aa of the second unit cell 12 is formed.

With regard to the battery cell and the method of manufacturing the battery cell of the present disclosure, the description is centered on a first electrode tab first side portion 21a. However, even in this disclosure, all of the descriptions related to a first electrode tab second side portion 21b, a second electrode tab first side portion 22a, and a second electrode tab second side portion 22b described above may be applied.

Therefore, in one Embodiment, the preparing the electrode assembly 100 may be performed by laminating unit cells that satisfy the conditions specified in the present disclosure.

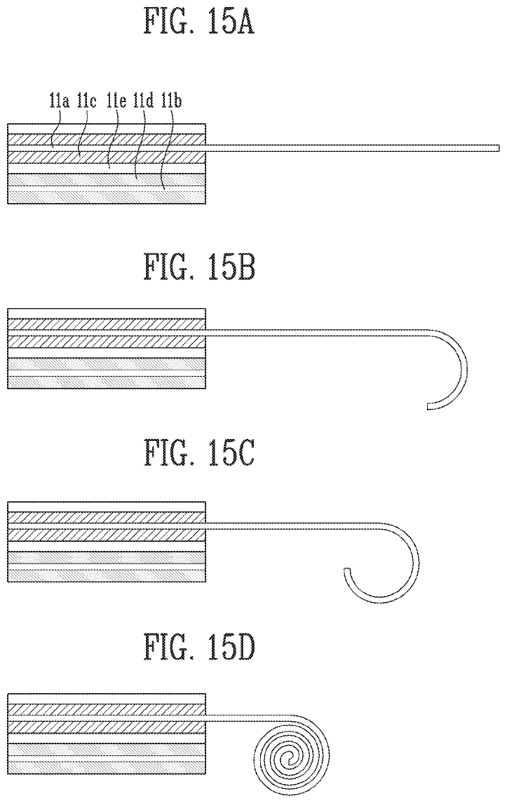

In one Embodiment, the rolling may be performed clockwise or counterclockwise. FIGS. 15B, 15C and 15D show aspects in which the winding is performed clockwise.

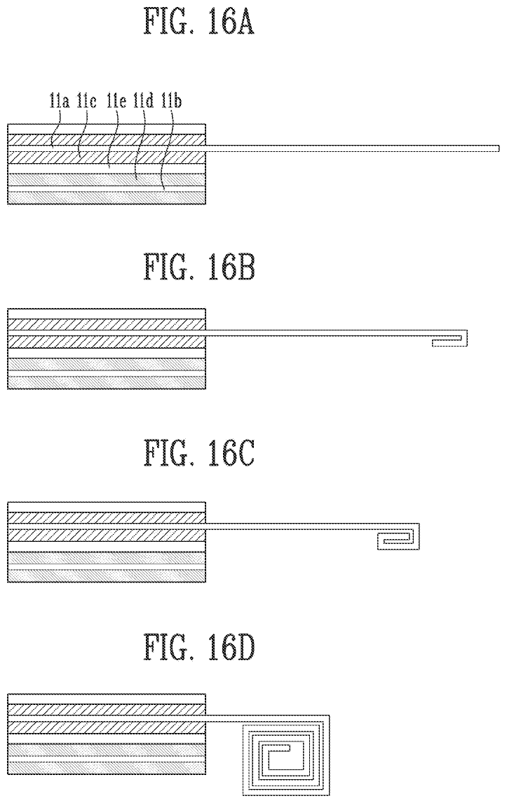

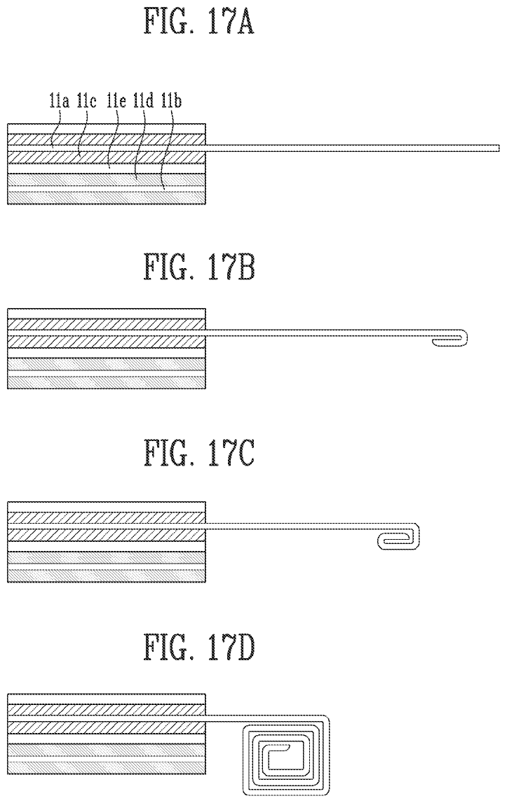

In one Embodiment, the folding may be performed clockwise or counterclockwise. In addition, the folding may be performed by folding the current collector in an angular shape. In addition, the folding may be performed by folding the current collector in a round shape. FIGS. 16A, 16B, 16C and 16D show aspects in which the folding is performed clockwise and the folding is performed by folding the current collector in an angular shape. FIGS. 17A, 17B, 17C and 17D show aspects shows an aspect in which the folding is performed counterclockwise and the folding is performed by folding the current collector in a round shape.

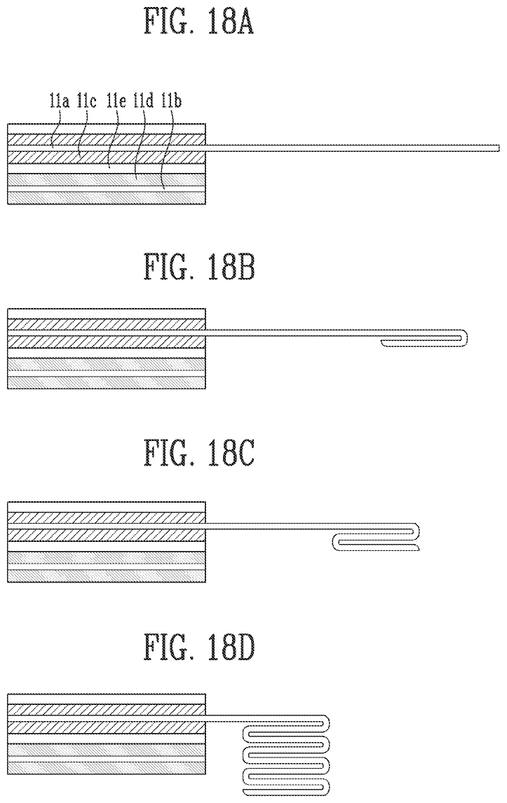

In one Embodiment, the folding may be performed in a zigzag direction. FIGS. 18A, 18B, 18C and 18D show aspects in which the folding is performed in a zigzag direction.

What is claimed is:

1. An electrode assembly comprising:
a unit cell stack comprising a first unit cell and a second unit cell which is the closest unit cell on the first unit cell, each of the first unit cell and the second unit cell comprising a first electrode comprising a first current collector and a first active material layer on at least one surface of the first current collector, a second electrode, which is an opposite electrode of the first electrode, comprising a second current collector and a second active material layer on at least one surface of the second current collector, and a separator interposed between the first electrode and the second electrode; and
a first electrode tab first side portion comprising a first current collector first side deformation portion in which one end in the width direction of the first current collector of each of the first unit cell and the second unit cell is folded or rolled,
wherein a shortest distance from an upper surface of the first current collector of the second unit cell to an upper surface of the first current collector of the first unit cell is the same as the height of the first current collector first side deformation portion of the second unit cell.

2. The electrode assembly according to claim 1,
wherein the electrode assembly further comprises a second electrode tab second side portion comprising a second current collector second side deformation portion in which the other end in the width direction of the second current collector of each of the first unit cell and the second unit cell is folded or rolled, and
wherein a shortest distance from an upper surface of a second current collector of the second unit cell to an upper surface of a second current collector of the first unit cell is the same as the height of a second current collector second side deformation portion of the second unit cell.

3. The electrode assembly according to claim 1,
wherein the electrode assembly further comprises a second electrode tab first side portion comprising a second current collector first side deformation portion in which one end in the width direction of the second current collector of each of the first unit cell and the second unit cell is folded or rolled, and
wherein a shortest distance from an upper surface of a second current collector of the second unit cell to an upper surface of a second current collector of the first unit cell is the same as the height of a second current collector first side deformation portion of the second unit cell.

4. The electrode assembly according to claim 1,
wherein the first unit cell and the second unit cell are alternately laminated.

5. The electrode assembly according to claim 1,
wherein the first electrode tab first side portion further comprises a first current collector first side undeformed portion which is between the unit cell stack and the first current collector first side deformation portion and in which a first current collector of each of the first unit cell and the second unit cell is extended in the width direction,
wherein the first current collector first side undeformed portion of the first unit cell is parallel to the first current collector first side undeformed portion of the second unit cell, and
wherein the length of the first current collector first side undeformed portion of the first unit cell is the same as the length of the first current collector first side undeformed portion of the second unit cell.

6. The electrode assembly according to claim 2,
wherein the first electrode tab first side portion further comprises a first current collector first side undeformed portion which is between the unit cell stack and the first current collector first side deformation portion and in which a first current collector of each of the first unit cell and the second unit cell is extended in the width direction,
wherein the second electrode tab second side portion further comprises a second current collector second side undeformed portion which is between the unit cell stack and the second current collector second side deformation portion and in which a second current collector of each of the first unit cell and the second unit cell is extended in the width direction,
wherein the first current collector first side undeformed portion of the first unit cell is parallel to the first current collector first side undeformed portion of the second unit cell,
wherein the second current collector second side undeformed portion of the first unit cell is parallel to the second current collector second side undeformed portion of the second unit cell,
wherein the length of the first current collector first side undeformed portion of the first unit cell is the same as the length of the first current collector first side undeformed portion of the second unit cell, and
wherein the length of the second current collector second side undeformed portion of the first unit cell is the same as the length of the second current collector second side undeformed portion of the second unit cell.

7. The electrode assembly according to claim 3,
wherein the first electrode tab first side portion further comprises a first current collector first side undeformed portion which is between the unit cell stack and the first current collector first side deformation portion and in which a first current collector of each of the first unit cell and the second unit cell is extended in the width direction,
wherein the second electrode tab first side portion further comprises a second current collector first side undeformed portion which is between the unit cell stack and the second current collector first side deformation portion and in which a second current collector of each of the first unit cell and the second unit cell is extended in the width direction,
wherein the first current collector first side undeformed portion of the first unit cell is parallel to the first current collector first side undeformed portion of the second unit cell,
wherein the second current collector first side undeformed portion of the first unit cell is parallel to the second current collector first side undeformed portion of the second unit cell,
wherein the length of the first current collector first side undeformed portion of the first unit cell is the same as the length of the first current collector first side undeformed portion of the second unit cell, and
wherein the length of the second current collector first side undeformed portion of the first unit cell is the same as the length of the second current collector first side undeformed portion of the second unit cell.

8. The electrode assembly according to claim 5,
wherein the first unit cell and the second unit cell are alternately laminated.

9. The electrode assembly according to claim 1,
wherein the unit cell stack further comprises a third unit cell and a fourth unit cell which is the closest unit cell on the third unit cell,
wherein each of the third unit cell and the fourth unit cell comprises a first electrode comprising a first current collector and a first active material layer on at least one side of the first current collector, a second electrode, which is an opposite electrode of the first electrode, comprising a second current collector and a second active material layer on at least one side of the second current collector, and a separator interposed between the first electrode and the second electrode,
wherein the first electrode tab first side portion further comprises a first current collector first side deformation portion in which one end in the width direction of the first current collector of each of the third unit cell and the fourth unit cell is folded or rolled,
wherein a shortest distance from an upper surface of a first current collector of the fourth unit cell to an upper surface of a first current collector of the third unit cell is the same as the height of a first current collector first side deformation portion of the fourth unit cell, and
wherein a shortest distance from an upper surface of a first current collector of the fourth unit cell to an upper surface of a first current collector of the third unit cell is the same as a shortest distance from an upper surface of a first current collector of the second unit cell to an upper surface of a first current collector of the first unit cell.

10. The electrode assembly according to claim 1,
wherein the unit cell stack further comprises a third unit cell and a fourth unit cell which is the closest unit cell on the third unit cell,
wherein each of the third unit cell and the fourth unit cell comprises a first electrode comprising a first current collector and a first active material layer on at least one side of the first current collector, a second electrode which is an opposite electrode of the first electrode, comprising a second current collector and a second active material layer on at least one side of the second current collector, and a separator interposed between the first electrode and the second electrode,
wherein the first electrode tab first side portion further comprises a first current collector first side deformation portion in which one end in the width direction of the first current collector of each of the third unit cell and the fourth unit cell is folded or rolled,
wherein a shortest distance from an upper surface of a first current collector of the fourth unit cell to an upper surface of a first current collector of the third unit cell is the same as the height of a first current collector first side deformation portion of the fourth unit cell, and
wherein a shortest distance from an upper surface of a first current collector of the fourth unit cell to an upper surface of a first current collector of the third unit cell is different from a shortest distance from an upper surface of a first current collector of the second unit cell to an upper surface of a first current collector of the first unit cell.

11. A battery cell comprising an electrode assembly of claim 1 and an electrode lead connected to a first electrode tab first side portion of the electrode assembly.

12. A method for manufacturing a battery cell, the method comprising:
preparing an electrode assembly of claim 1; and
connecting an electrode lead to a first electrode tab first side portion of the electrode assembly.

13. The method for manufacturing a battery cell according to claim 12,
wherein the preparing the electrode assembly comprises:
preparing a unit cell stack comprising a first unit cell and a second unit cell which is the closest unit cell on the first unit cell, wherein each of the first unit cell and the second unit cell comprising a first electrode comprising a first current collector and a first active material layer on at least one surface of the first current collector, a second electrode, which is an opposite electrode of the first electrode, comprising a second current collector and a second active material layer on at least one surface of the second current collector, and a separator interposed between the first electrode and the second electrode; and
folding or rolling one end in the width direction of the first current collector of each of the first unit cell and the second unit cell to form a first electrode tab first side portion comprising a first current collector first side deformation portion in which a shortest distance from an upper surface of the first current collector of the second unit cell to an upper surface of the first current collector of the first unit cell is the same as the height of the first current collector first side deformation portion of the second unit cell.

14. The method for manufacturing a battery cell according to claim 12,
wherein the preparing the electrode assembly comprises:
folding or rolling one end in the width direction of a first current collector to prepare the first unit cell in which the first current collector first side deformation portion is formed; and
folding or rolling one end in the width direction of a first current collector to locate the second unit cell in which the first current collector first side deformation portion is formed on the first unit cell,
wherein the preparing the first unit cell and the locating the second unit cell are performed such that a first electrode tab first side portion comprising a first current collector first side deformation portion in which a shortest distance from an upper surface of a first current collector of the second unit cell to an upper surface of a first current collector of the first unit cell is the same as the height of a first current collector first side deformation portion of the second unit cell is formed.

15. The method for manufacturing a battery cell according to claim 13
wherein the rolling is performed clockwise or counterclockwise.

16. The method for manufacturing a battery cell according to claim 14,
wherein the rolling is performed clockwise or counterclockwise.

17. The method for manufacturing a battery cell according to claim 13,
wherein the folding is performed clockwise or counterclockwise.

18. The method for manufacturing a battery cell according to claim 14,
wherein the folding is performed clockwise or counterclockwise.

19. The method for manufacturing a battery cell according to claim 13,
wherein the folding is performed in a zigzag direction.

20. The method for manufacturing a battery cell according to claim 14,
wherein the folding is performed in a zigzag direction.
